(19) United States
(12) Patent Application Publication
(10) Pub. No.: US 2026/0183874 A1
(43) Pub. Date: Jul. 2, 2026

(54) BEAM LINE FOR A LASER BEAM, LASER SYSTEM, AND TLE SYSTEM

(71) Applicant: Max-Planck-Gesellschaft zur Förderung der Wissenschaften e.V., München (DE)

(72) Inventors: Wolfgang Braun, Bietigheim-Bissingen (DE); Jochen Mannhart, Böblingen (DE); Johannes Arnoldus Boschker, Stuttgart (DE)

(21) Appl. No.: 19/127,600

(22) PCT Filed: Nov. 24, 2022
(86) PCT No.: PCT/EP2022/083187

§ 371 Date: May 6, 2025

(51) Int. Cl. B23K 26/70; B23K 26/082; B23K 26/12; G02B 26/08

(52) U.S. Cl. CPC B23K 26/705; B23K 26/0821; B23K 26/128; G02B 26/0816

(57) ABSTRACT

The invention relates to a beam line for a laser beam of a thermal laser evaporation (TLE) system. The beam line extends between a source end of the beam line and a chamber end of the beam line. The source end is connectable to a laser source and the chamber end is connectable to a reaction chamber of the TLE system.

The invention relates to a beam line for a laser beam of a thermal laser evaporation (TLE) system, the beam line extending between a source end of the beam line and a chamber end of the beam line, whereby the source end is connectable to a laser source and the chamber end is connectable to a reaction chamber of the TLE system, the beam line comprising:
one or more optical sections for altering and/or controlling properties of the laser beam, and/or
one or more linear guidance sections;
   wherein each of the optical sections and of the guidance sections, respectively, comprises a housing with an upstream end comprising a first connection interface, a downstream end comprising a second connection interface, and a section cavity continuously extending within the housing from a first section opening in the upstream end to a second section opening in the downstream end: Further, the invention relates to a laser system for a TLE system, comprising a laser source for providing a laser beam, and a respective beam line according to the present invention. Also, the invention relates to a TLE system comprising a reaction chamber fillable with a reaction atmosphere, a substrate arranged in the reaction chamber, one or more sources arranged in the reaction chamber, and a respective laser system according to the present invention for providing a laser beam for evaporating and/or sublimating a material of the source and/or for heating a material of the substrate.

In TLE, source material is evaporated and/or sublimated in a controlled environment, in particular in a reaction chamber filled with a reaction atmosphere, by means of laser heating, usually with the intent to coat a substrate likewise arranged in the reaction chamber. Additionally, in many applications also a heating of the substrate is of advantage, which can also be provided by accordingly adjusted laser light impinging on the respective substrate.

In both cases, a laser beam suitable for the respective task has to be provided. Laser beams are generated in laser sources, which are almost always arranged outside of the reaction chamber. Hence, the respective laser beam provided by the laser source has to be guided into the reaction chamber for impinging onto the source or the substrate, respectively. Whereas for shorter wavelength lasers, in particular lasers with approximately 1 μm wavelength, appropriate fibers exist to conveniently route the laser light from the source to a point of use, such fibers with reasonably low absorption do not exist for short (ultraviolet, UV) or long wavelength laser sources such as the ˜10 μm wavelength CO₂ laser particularly useful for substrate heating.

In addition, for the intended usage of the laser beam, evaporation and/or sublimation of source material, and heating of the substrate, respectively, the initial properties of the laser beam provided by the laser source itself might not be ideal. Said properties of the laser beam may include for instance direction, size, shape, focal length, spatial intensity distribution, and/or overall intensity. Hence, also altering and/or controlling said properties of the laser beam between the laser source and its final destination within the reaction chamber is necessary in most of the applications.

Optical setups for laser beam lines of the state of the art, especially for laser beams with long wavelengths of around 10 μm, need to combine three functions: mechanical support of the optical components, a light tight enclosure, and the possibility to flood the beam path with an inert gas for preventing absorption of the laser beam. Usually, the mechanical support is realized by an optical table, providing no enclosure, while the enclosure, which has to cover the complete setup on the optical table to contain the optical beams and the purge gas, does not provide mechanical support for the optical components. Especially for the intended usage of the laser beam for a TLE system, such solutions based on optical tables are not suitable.

In view of the above, it is an object of the present invention to provide an improved beam line for a laser beam, an improved laser system, and an improved thermal laser evaporation system which do not have the aforementioned drawbacks of the state of the art. In particular, it is an object of the present invention to provide an improved beam line for a laser beam, an improved laser system, and an improved thermal laser evaporation system which provide a simple and unified structure for guiding a laser beam provided by a laser source to a reaction chamber of a TLE system, which in particular provides mechanical support for necessary means for altering and/or controlling properties of the laser beam, and simultaneously encloses the laser beam on its path through the beam line, preferably also provides a containment of a purge gas.

This object is satisfied by the respective independent patent claims. In particular, this object is satisfied by a beam line for a laser beam according to independent claim 1, by a laser system according to independent claim 42, and by a thermal laser evaporation system according to independent claim 45. The dependent claims describe preferred embodiments of the invention. Details and advantages described with respect to beam line according to the first aspect of the invention also refer to a laser source according to the second aspect of the invention and to a thermal laser evaporation system according to the third aspect of the invention, and vice versa, if of technical sense.

According to a first aspect of the invention the object is satisfied by a beam line for a laser beam of a thermal laser evaporation (TLE) system, the beam line extending between a source end of the beam line and a chamber end of the beam line, whereby the source end is connectable to a laser source and the chamber end is connectable to a reaction chamber of the TLE system, the beam line comprising two or more of:
one or more optical sections for altering and/or controlling properties of the laser beam, and/or
one or more linear guidance sections;
   wherein each of the optical sections and of the guidance sections, respectively, comprises a housing with an upstream end comprising a first connection interface, a downstream end comprising a second connection interface, and a section cavity continuously extending within the housing from a first section opening in the upstream end to a second section opening in the downstream end, wherein the one or more optical sections and the one or more guidance sections are arranged adjacent in pairs such that the respective section cavities form a continuous beam cavity extending from the source end to the chamber end, and wherein each section pair of adjacently arranged optical sections and/or guidance sections are arranged by connecting the first connection interface of one section of the section pair and the second connection interface of the other section of the section pair.

The beam line according to the present invention is intended for a usage as part of a TLE system. Said TLE system normally at least comprises a reaction chamber, in which a source with material to be evaporated and/or sublimated and a substrate to be coated by said evaporated and/or sublimated source material are arranged. A laser source provides a laser beam, which is used for said evaporation and/or sublimation, or which is used for heating the substrate for improving the coating process.

A secure guidance of the laser beam from the laser source to reaction chamber is crucial for the functionality of the TLE system. For providing this, the beam line according to the present invention is constructed such that it extends from the laser source up to the reaction chamber. A source end of the beam line connectable to the laser source and a chamber end connectable to the reaction chamber ensure that the respective connections to the laser source and the reaction chamber can be established. Besides the beam line according to the present invention, no other guiding means is necessary for guiding the laser beam provided by the laser source to a reaction chamber of the TLE system.

The beam line according to the present invention is made of two or more sections, wherein the sections can be provided in two different versions, namely optical sections and linear guidance sections. In other words, the sections of the beam line according to the present invention can consist of two optical sections, or consist of two guidance sections, or comprise any combinations of one or more optical sections and one or more guidance sections.

The optical sections constructed such that each of them can alter and/or control one or more properties of the laser beam, exemplarily a mean direction of the laser beam by simply reflecting the laser beam on a mirror tilted to the direction of the impinging laser beam, or a shape of the laser beam by cutting parts of the laser beam, for instance by an accordingly shaped aperture. The guidance sections are used as an enclosed path for the laser beam, shielding it with respect to the environment.

Both sections share the construction with a housing, wherein the housing comprises a section cavity extending between a first section end in an upstream end of the housing and a second section end in a downstream end of the housing. Said section cavity is used for the path of the laser beam. For that, the size of the cross section of the section cavity perpendicular to the direction of the laser beam is chosen such that the laser beam can propagate within the section cavity without hitting an inner surface of the section cavity. Thereby, during operation of the TLE system, the laser beam enters the section cavity of the respective optical section or guidance section through the first section opening, travels within the respective section through the section cavity, and leaves the respective section again through the second section opening.

The respective housing of the sections can be made of metal, for instance aluminum. For instance, the production of said sections can include machining the housing out of a monolithic block of metal. Whereas the guidance sections are simply linear structures, in which the section cavity goes straight and linear from the first section opening to the second section opening, the shape of the section cavity of the optical sections can be different, for instance comprising two straight sections connected to each other. This allows especially altering and/or controlling a direction of the laser beam.

In an optical section, suitable means are arranged within the respective section cavity allowing altering and/or controlling properties of the laser beam. In other words, the optical sections provide in their section cavities the necessary mechanical support for the respective means. In contrast to that, the section cavity of a guidance section is empty and without such means.

According to the present invention, the housings of the optical sections and guidance sections are further constructed such that they carry at their respective upstream end a first connection interface and at their respective downstream end a second connection interface. Said connection interfaces again are constructed accordingly to each other such that each first connection interface can be connected to any second connection interface. In other words, any pair of optical sections and guidance sections can be attached to each other in any sequence, namely optical-optical, optical-guidance, guidance-optical, and guidance-guidance, respectively.

Consequently, in any pair of optical sections and guidance sections, the respective sections can be adjacently arranged with respect to each other. Adjacent in the sense of the present invention means directly adjacent respectively at either side of a link connecting two sections. Hence, the downstream section of a first pair of sections can also be the upstream section of a subsequent second pair of sections. Hence, the beam line according to the present invention can comprise a plurality of sections subsequently arranged on each other. Arbitrary long distances between the laser source and the reaction chamber can thereby be bridged by the beam line according to the present invention. However, if sufficient, also a beam line consisting of a single pair of sections is possible.

In particular, by combining a plurality of two or more sections, independent of whether they are optical sections, guidance sections, or both, the respective section cavities are connected to each other, forming a continuous beam cavity starting at the first opening in the upstream end of the respective first section of the plurality of combined sections, and ending at the second opening in the downstream end of the respective last section of the plurality of combined sections. As a result, the beam cavity continuously extends from the source end to the chamber end of the resulting beam line. In other words, the beam line according to the present invention provides an enclosure for the laser beam starting at the source end, and hence at the laser source, and extends to the chamber end, and hence to the reaction chamber. As said beam cavity extends continuously, it can also be used for containing a purge gas.

In summary, the beam line according to the present invention is a simple unified structure for guiding a laser beam provided by a laser source to a reaction chamber of a TLE system. It provides mechanical support in its optical sections for necessary means for altering and/or controlling properties of the laser beam, and simultaneously encloses the laser beam on its path through the beam line. Additionally, also a containment of a purge gas can be provided, if suitable.

Further, the beam line according to the present invention can comprise that the first connection interfaces and the second connection interfaces are adapted with respect to each other for providing a gas tight and/or light tight connection of the respective section cavities. Preferably, the provided connections of the respective section cavities are both, gas tight and light tight, respectively. In the sense of the present invention, both, light tight and gas tight, respectively, are to be understood in such a way that the respective tightness is provided with respect to the environment. The connections between the respective sections are weak points along the beam line with respect to tightness, both gas tightness and light tightness, respectively, as the respective section cavities themselves can easily be provided gas tight and/or light tight, respectively. However, by providing first connection interfaces and second connection interfaces accordingly adapted to each other, a gas tight and/or light tight connection also between two adjacently arranged sections can be ensured. According adaptations of said connection interfaces can be for instance tongue and groove sections in the respective connection interfaces, or dedicated sealing means. Also, precise machining of said connection interfaces supports said adaptation.

As an enhancement of the beam line according to the present invention, both the first connection interfaces and the second connection interfaces can comprise one or more respective arrangement spaces for precisely fitting alignment elements of the beam line for aligning the section pair of adjacently arranged optical sections and/or guidance sections. In other words, by the precise fitting of said alignment elements in the respective arrangement space of each of the connection interfaces, the relative positioning of the respective adjacently arranged optical sections and/or guidance sections can be provided in a very precise way. Thereby, a precise alignment of the two elements of a section pair can be provided, wherein said precise alignment automatically improves a gas tightness and light tightness, respectively, of said connection.

According to a further enhanced embodiment of the beam line according to the present invention, the arrangement spaces surround the respective section opening and the alignment element is ring-shaped, and/or wherein the arrangement spaces are bores and the alignment element is a screw or bolt for fixing the respective section pair of adjacently arranged optical sections and/or guidance sections on each other. This list is not complete and can be expanded by further embodiments of arrangement spaces and accordingly shaped alignment elements which precisely fit into the respective arrangement spaces in the first and second connection interface, respectively.

Additionally, the beam line according to the present invention can be improved by that, for providing a gas tight and/or light tight connection of the respective section cavities, the first connection interfaces comprise an elastomer seal surrounding the first section opening and/or the second connection interfaces comprise an elastomer seal surrounding the second section opening. As mentioned above, dedicated sealing means can be used for providing a gas tight and/or light tight connection. Elastomer seals, for instance O-rings, are a suitable choice for such sealing means. By surrounding the respective opening in the end of the section, sealing the respective opening can be reliably provided. Said elastomer seals can be provided in one or both connection interfaces, for instance with different radii. Further, they can be supported by respective grooves of the connection interfaces, both in the connection interface carrying the elastomer seal, and/or in the complementary connection interface, respectively.

The beam line according to the present invention can also be characterized in that the one or more optical sections comprise an optical element arranged in the respective section cavity, wherein the optical element is capable of altering and/or controlling one or more properties of a laser beam entering the section cavity through the first section opening such that the altered laser beam leaves the section cavity through the second section opening. In other words, within the section cavity of the respective optical section suitable means for mechanical support of the respective optical element are provided. By ensuring that the laser beam, whose properties are altered and/or controlled by the optical means, again leaves the section cavity through the second opening, an interruption of the laser beam by the respective optical section can be prohibited.

For example, the optical element can be a flat mirror and the altered property of the laser beam can be a direction of the laser beam, altered by a simple reflection on the mirror. By that, corner pieces of the beam line can be provided easily, especially without the risk of blocking the laser beam.

According to a further improvement, the beam line according to the present invention can comprise that the optical element is capable of altering and/or controlling the laser beam such that a laser beam entering the section cavity essentially parallel to a central axis of the first section opening leaves the section cavity essentially parallel to a central axis of the second section opening. In other words, as the guidance sections do not alter the alignment of the laser beam, by providing all optical sections with respectively constructed optical elements, a laser beam entering the beam line according to the present invention at the source end parallel to said central axis, stays throughout the beam line parallel to the central axis actually present at the respective part of the beam line, and also exits the beam line at the chamber end parallel to the central axis of the last section cavity of the last section of the beam line.

In addition, the guidance sections between the respective optical sections of the beam line can be of arbitrary length, as they do not affect the parallel alignment of the laser beam with respect to the respective central axis. This provides enormous flexibility in routing the beam line from the laser source to the reaction chamber. In particular, the geometry of the entire beam line may be changed and reconfigured without affecting the shape of the laser beam or the performance and final intensity distribution of the beam line. The optical path remains unaffected. This holds especially true for laser beams which are rotationally symmetric.

Additionally, the beam line according to the present invention can be improved by that the central axis of the first section opening is perpendicular to the central axis of the second section opening. Hence, the direction of the laser beam can be altered by 90° by the respective optical section. As the laser beam stays parallel to the central axis at the second opening in the downstream end of the respective optical section, all other properties of the laser beam, such as for instance shape, spatial intensity distribution and/or focal length, can be remain unaffected. However, if the optical element is accordingly capable and/or more optical elements are present in the respective section cavity of the optical element, additionally to the altered direction, also altering and/or controlling of other properties of the laser beam is possible.

In another embodiment, the beam line according to the present invention can comprise that the section cavity of the one or more guidance sections extends linearly from the first section opening to the second section opening along a common central axis of the first section opening and the second section opening. In other words, the section cavity is of tubular shape limited by section openings, which are parallel to each other and which additionally share a common central axis. Said common central axis preferably also forms the central axis of the tubular section cavity. By that way of construction, it can easily be ensured that the respective guidance section does not affect the parallel alignment of the laser beam with respect to the respective central axis.

Further, the beam line according to the present invention can be characterized in that the beam line comprises a laser entry section, wherein the laser entry section forms the source end, comprises a second connection interface, and is connectable in a gas tight and/or light tight manner to the laser source, and/or wherein the beam line comprises a chamber exit section, wherein the chamber exit section forms the chamber end, comprises a first connection interface, and is connectable in a gas tight and/or light tight manner to the reaction chamber. By providing said laser entry section, it can be ensured for the source end of the beam line that both, a gas tight and/or light tight connection to the laser source, and also a connection to the first connection interface on the upstream end of the first section of the beam line, respectively, can be established. Likewise, by providing said chamber exit section, it can be ensured for the chamber end of the beam line that both, a gas tight and/or light tight connection to the reaction chamber, and also a connection to the second connection interface on the downstream end of the last section of the beam line, respectively, can be established. A gas tight and/or light tight connection on both ends of the beam line can thereby be provided. In other words, the beam line according to the present invention can be constructed such that it provides a connection between the laser source and the reaction chamber which is gas tight and light tight with respect to the environment.

In addition, the beam line according to the present invention can be improved by that the chamber exit section comprises a bellows and/or the laser entry section comprises a bellows. A bellows is an elastic element with a cavity, which, as part of the chamber exit section and/or the laser entry section, shields the region between the last optical section or guidance section of the beam line and the reaction chamber and/or between the first optical section or guidance section of the beam line and the laser system to prevent laser light and/or gas leaks in this area, while at the same time mechanically disconnects the beam line from the reaction chamber and/or the laser system. Thereby, decoupling vibrations and avoiding other problems such as mechanical stress due to thermal expansion and the like between the beam line and the reaction chamber and/or the laser system can be provided.

According to a further improved embodiment of the beam line according to the present invention, the chamber exit section comprises a chamber window, which is arrangeable at a flange of the reaction chamber. Hence, the beam line ends with the chamber window. As said chamber window is arrangeable at a flange of the reaction chamber, no additional fixing means and sealing means are needed for arranging the chamber exit section of the beam line according to the present invention at the reaction chamber of the TLE system, in particular on a chamber window of the reaction chamber. Already the chamber exit section and its chamber window comprise all means for sealing the reaction chamber of the TLE system at hand, for instance elastomer seals such as O-rings, and/or circular sharp edges for forming a knife seal. Thereby, the setup of the TLE system can be simplified.

Also, the beam line according to the present invention can be characterized in that the beam line comprises a gas system for providing a flow of purge gas within the beam cavity. For some laser beams absorption in an atmosphere present on its way through the beam line might be an issue, for instance water vapor causes strong absorption of infrared laser beams, especially with a wavelength around 10 μm. A gas system as part of the beam line according to the present invention can be used to solve this issue, as said gas system can provide a flow of a purge gas within the beam cavity of the beam line. Said purge gas can preferably be chosen with respect to the wavelength of the laser beam to be guided in the beam line for minimizing the risk of absorption of the laser beam on its way from the source end to the chamber end of the beam line.

In addition, the beam line can be improved by that one or more inlets of the gas system for injecting the purge gas into the beam cavity, and one or more outlets of the gas system for extracting the purge gas out of the beam cavity are connected to the beam cavity such that the flow of purge gas is provided within the entire beam cavity between the source end and the chamber end. The source end and the chamber end, respectively, mark the beginning and the end, respectively, of the beam cavity. An accordingly arranged at least one inlet of the gas system and a likewise accordingly arranged at least one outlet of the gas system provide a flow of purge gas through the complete beam cavity. The flow direction of the purge gas is not decisive and can be selected as desired.

According to a first alternative improvement, the beam line according to the present invention can comprise that the inlet is connected to the laser entry section and the outlet is connected to the chamber exit section. If present, along the propagation of the laser beam the laser entry section forms the very first element of the source end, and the chamber exit section forms the very last element of the chamber end, respectively. Hence, by providing the inlet of the gas system at the laser entry section and the outlet of the gas system at the chamber exit section, ensuring a flow of purge gas through the complete beam cavity can be improved further.

According to a second alternative improvement, the beam line according to the present invention can comprise that the outlet is connected to the laser entry section and the inlet is connected to the chamber exit section. Again if present, along the propagation of the laser beam the laser entry section forms the very first element of the source end, and the chamber exit section forms the very last element of the chamber end, respectively. Hence, also by providing the outlet of the gas system at the laser entry section and the inlet of the gas system at the chamber exit section, ensuring a flow of purge gas through the complete beam cavity can be improved further.

According to a third alternative improvement, the beam line according to the present invention can comprise that one inlet is connected to the laser entry section and one inlet is connected to the chamber exit section and one outlet is connected to the beam cavity between the source end and the chamber end, or that one outlet is connected to the laser entry section and one outlet is connected to the chamber exit section and one inlet is connected to the beam cavity between the source end and the chamber end. Again if present, along the propagation of the laser beam the laser entry section forms the very first element of the source end, and the chamber exit section forms the very last element of the chamber end, respectively. Hence, also by providing one inlet each at the laser entry section and the chamber exit section, and by providing one outlet connected to the beam cavity somewhere in between, or vice versa, ensuring a flow of purge gas through the complete beam cavity can be improved further.

Further, the beam line according to the present invention can also be improved by that dry air or pure nitrogen is used as purge gas. Dry air and also pure nitrogen are purge gases essentially without water vapor. Hence, especially for infrared laser beams, in particular with a wavelength about 10 μm, dry air and pure nitrogen are suitable purge gases for preventing absorption of the laser beam within the beam line according to the present invention.

In yet another embodiment, the beam line according to the present invention can be characterized in that respective housings of the one or more optical sections and the one or more linear guidance sections are mechanically rigid or at least inherently stiffenable, and wherein the first connection interfaces and the second connection interfaces are adapted with respect to each other for providing a mechanically rigid connection. In other words, in each of the sections, both optical sections and guidance sections, respectively, the spatial orientation and position of the upstream and downstream end with respect to each other is fixed or can be fixed and does not change under mechanical stress. In addition, as also the connections of respective first connection interfaces and second connection interfaces are mechanically rigid, as a result, this fixation of relative spatial positioning and orientation can also be made possible for the source end and the chamber end of the beam line. In other words, the beam line according to the present invention can be provided in a self-supporting manner.

Also, the beam line can comprise that the housing of the one or more linear guidance sections is a tubular extruded aluminum section. A tubular extruded section can provide the advantage of high stiffness due to the tubular shape, in particular with respect to torque around its longitudinal axis. Ribs, both along an axis of the tubular shape and circumferential, can even enhance said stiffness. In addition, using aluminum as material provides that said sections are lightweight and have a very good heat conduction, which prevents local bending due to localized thermal expansion.

Further, the beam line according to the present invention can be improved by that grooves for fixation on a support structure are provided on an outer surface of the housing. As mentioned above, the beam line according to the present invention as a whole can be provided self-supporting. However, it can be of advantage for providing an overall support for the beam line, for instance for ensuring a fixed relative positioning and/or orientation of the complete beam line with respect to the laser source and/or the reaction chamber, and/or if the beam line as such has to be supported to prevent it from tipping over as a whole. By providing grooves on an outer surface of the housing, especially of the extruded tubular aluminum sections, a fixation on any additionally provided external support can be realized easily.

In another embodiment, the beam line according to the present invention can comprise that one or more threaded holes are provided in the first connection interface and/or in the second connection interface of the housing. Said threaded holes can be provided in the housing of both, optical sections, and guidance sections, respectively. In such threaded holes, respective screws can be inserted and fixed, in particular for providing a connection of a first connection interface and a second connection interface on each other. Especially, said screws in the threaded holes are an easy and secure way for providing a mechanically rigid connection between a respective first connection interface and a respective second connection interface.

The beam line according to the present invention can be improved further by that two or more threaded holes are arranged around the respective first section opening and/or second section opening in a rotational symmetric pattern, in particular a 180° or 120° or 90° or 72° or 60° 45° or 40° or 30° or 20° or 10° or 5° rotational symmetric pattern, around a central axis of the respective first section opening and/or second section opening. Thereby, the number of threaded holes defines the rotational symmetric pattern, and vice versa. In other words, any pair of sections sharing this positioning of the threaded holes can be arranged on each other in several specific different orientations, respectively defined by the present embodiment of the rotational symmetric pattern. Especially for rotationally symmetric laser beams, any such rotation does not affect the shape of the beam at the sample position or elsewhere along the beamline. The beam line may therefore be ‘folded’ in many different ways according to lab or fab space, placement of the laser source, size and position of the reaction chamber, and so on.

Alternatively, or additionally, the beam line according to the present invention can comprise that the first connection interface and the second connection interface are provided rotationally symmetric, and whereby the beam line comprises clamping means for securely fixing a section pair of adjacently arranged optical sections and/or guidance sections. In this embodiment, two sections, either optical or guidance or a mixed pair, comprise rotational symmetric connection interfaces. By fixing these sections together by the clamping means, any relative rotation between these sections can be provided. All advantages described in the previous paragraph can thereby also provided by the embodiment described in the present paragraph, but additionally the two sections can even be freely rotated with respect to each other. The degrees of freedom when setting up the beam line according to the present invention can thereby be improved further.

Further, the beam line according to the present invention can characterized in that the surface of the section cavity is anodized for providing an oxide layer on said surface of the section cavity. Anodizing the surface of the section cavity, especially if the respective optical section or guidance section is made of aluminum, ensures a rather thick oxide layer on said surface. Together with a low divergence of the laser beam along the optical path and therefore low incidence angles on the walls, this leads to a good absorption of stray radiation in the surface of the respective section cavity, thereby reducing stray radiation at the position of the source or the substrate in the reaction chamber. In particular, laser radiation at wavelengths around 10 μm, as is most beneficial for the substrate heating of most materials, is particularly efficiently absorbed by aluminum oxide.

According to another embodiment, the beam line can comprise that the one or more optical sections alters and/or controls one or more of the following properties of the laser beam:
Direction;
Size;
Shape;
Polarization;
Focal length; and
Intensity distribution.

This list is not complete and can be expanded by further properties of laser beams. By altering and/or controlling one or more of said properties of the laser beam within the beam line, a laser beam with selected and controlled properties can be provided within the reaction chamber suitable for evaporation and/or sublimation of source material or heating of substrate material.

For improvement, the beam line can also be characterized in that the respective optical element of the one or more optical sections comprises one or more of the following elements:
A flat mirror;
A focusing mirror;
A defocusing mirror;
An axicon mirror;
A freeform mirror;
A Bragg mirror;
A diffractive mirror or grating; and
An aperture.

This list is not complete and can be expanded by further optical elements for altering and/or controlling properties of laser beams. Especially, the listing above contains mirrors for altering and/or controlling properties, which are most suitable for the usage with infrared laser beams, which are often used in TLE systems. However, most optical elements listed above as mirrors can also be constructed as transmitting elements such as lenses, if suitable for the actual usage, especially the used laser beam.

Additionally, the beam line can be improved further by that the active part of the respective optical element of the one or more optical sections is machined out of a monolithic block of metal, in particular copper. Metal, in particular copper, can be machined with extremely high precision, wherein further such machined surfaces comprise a high reflectivity for most of the laser beams usually used in TLE systems. Another example for a suitable metal is aluminum. Hence, machining the active part of an optical element out of a monolithic block of metal provides optical elements with high accuracy and high reflectivity.

According to another improved embodiment of the beam line according to the present invention, the optical element of the one or more optical sections comprises an actively adjustable mirror. “Actively adjustable” in the sense of the present invention means that the spatial orientation and/or the spatial shape of the mirror can be actively altered, in particular during operation of the laser source. Hence, the respective properties altered and/or controlled by the respective optical element can be actively adjusted during operation of the TLE system.

Further, the beam line according to the present invention can also be improved by that a spatial orientation of the actively adjustable mirror can be adjusted by adjustment screws and/or wherein the actively adjustable mirror comprises a reflective membrane on a cushion fillable with an adjustment fluid. Adjustment screws, in particular three adjustment screws, are an easy and reliable way of adjusting a spatial orientation of an adjustable mirror. Further, the spatial shape of a reflective membrane on a cushion strongly depends on the amount of filling in the cushion. Hence, adjusting the filling of the cushion is likewise an easy and reliable way of adjusting a spatial shape of an adjustable mirror.

According to an additional improvement, the beam line according to the present invention can comprise that the adjustment screws and/or a regulating connector for the adjustment fluid are accessible from the outside of the housing of the respective optical section. In both cases, the active adjustment of the orientation or shape, respectively, of the adjustable mirror can be provided without the need of direct access to the active part of the adjustable mirror itself, in other words without the need of opening the respective optical section of the beam line. Hence, it can be ensured very easily that the respective optical element can be actively adjusted during operation of the TLE system.

In addition, the beam line can also be characterized in that the one or more optical sections comprise cooling means for actively cooling the respective optical element. Metallic mirrors as preferably used as optical elements in the beam line according to the present invention are highly reflective. Nevertheless, they absorb small fractions of the impinging laser light. Actively cooling said mirrors compensates the energy deposit caused by absorbing impinging laser light and hence preserves the intended optical properties of the respective optical element.

Additionally, also apertures are optical elements in the sense of the present invention. Said apertures, which also can be machined out of a block of metal, are in contrast to mirrors used for blocking parts of the laser beam on purpose. A high amount of laser energy deposited into the bulk of said aperture is often unavoidable. Especially for apertures, an active cooling is of advantage for preserving the properties of the aperture, for instance preventing a change in shape due to thermal stress.

In a specialized improved embodiment, the beam line can comprise that the cooling means comprise cooling ducts for a coolant machined in and/or into the monolithic block of metal forming the active part of the respective optical element. As mentioned above, machining an active part of an optical element out of a monolithic block of metal provides the optical element with high precision. In addition, metal, especially copper and aluminum, are highly thermally conductive. By providing cooling ducts within the bulk of the monolithic block of metal, thermal energy deposited by an impinging laser beam can be transported away in a very efficient way.

In addition, the beam line can be characterized in that the beam line comprises beam diagnostic means for measuring properties of the laser beam. The main purpose of the beam line according to the present invention is providing the laser beam up to and hence within the reaction chamber with certain selected properties. In most cases, the TLE system comprises diagnostic means for measuring said properties. As mentioned above, the beam line according to the present invention can comprise optical sections with optical elements, which are adjustable, in particular actively adjustable. Hence it can be of advantage, for instance for a direct feedback of an adjustment applied to the adjustable optical element, to directly measure one or more properties of the laser beam within the beam line, and hence before the laser beam enters the reaction chamber. Beam diagnostic means provided by the beam line itself can provide said measurements.

According to one possible embodiment of the beam line according to the present invention, the beam diagnostic means comprise a pyrometer for measuring the temperature of an optical element of one of the optical sections. By measuring the temperature of an optical element, a deposition of energy absorbed out of the impinging laser beam can be measured. Hence, an intensity of the impinging laser beam can be calculated. Preferably, the pyrometer provides a temperature measurement with a spatial resolution for allowing a calculation of a spatial resolved intensity profile of the impinging laser beam.

Additionally, or alternatively, the pyrometer can also be used for measuring the temperature of a substrate or source heated by the laser beam. For that, the pyrometer is preferably arranged such that it sees the substrate or source along the beam axis of the laser beam, which can be provided by arranging a Bragg mirror of a semi-transparent optical element, such as for instance a beam splitter or a semi-transparent mirror, in the path of the laser beam and the respective pyrometer accordingly on the back side of the Bragg mirror or semi-transparent optical element, respectively.

In addition, a Bragg mirror comprises the feature that it is reflective only for a certain and especially narrow wavelength band. Laser light outside of said band transmits through the Bragg mirror and hence can be directly measured by the pyrometer. In this case, even a direct measurement of the substrate temperature can be provided by the pyrometer, at least of that part of the laser beam transmitted through the Bragg mirror.

Additionally, the beam line can be improved further by that an optical element of one of the optical sections altering the direction of the laser beam by 90°, in particular a Bragg mirror, can be removed and an additional beam line element is arranged and/or arrangeable at the position of the optical element or along the original direction of the laser beam, wherein the beam diagnostic means comprise a detector arranged at a measuring position in the additional beam line element. By removing said optical element, the laser beam is no longer reflected, propagates straight into the additional beam line element and can be investigated by the detector arranged within the additional beam line element for this purpose. The detector can preferably be arranged directly in the path of the laser beam. A direct measurement of properties of the laser beam can thereby be provided.

Additionally, the beam line according to the present invention can also comprise that the one of the optical sections is the last optical section before the chamber end and a measurement distance of the measuring position to the position of the removed optical element is chosen according to, preferably equal to, a working distance of the removed optical element to a substrate or source in the reaction chamber. The working distance is the distance between the optical element of said last optical section and the destination of the laser beam within the reaction chamber, namely a source or a substrate. Especially for laser beams which are aligned parallel to a central axis of the beam line, at least parallel to the central axis of the first opening of the one of the optical sections, this leads to a laser beam at the measurement position with properties which are directly related to the properties of the laser beam, which would be present at the working distance. In the case of equality between measurement distance and working distance, said properties are even essentially identical, differing only by small distortions caused by the chamber window. Measuring the properties of the laser beam at its destination within the reaction chamber can thereby be provided without opening the reaction chamber.

The beam line according to the present invention can further be improved by that the detector is a camera and/or a beam monitor and/or a canvas and/or a thermal paper. This list is not complete and can be expanded by other suitable detectors. All of the listed detectors can be used for investigating a spatially resolved image of an intensity distribution of the laser beam.

In another embodiment of the beam line according to the present invention, the beam line is a modular beam line comprising a plurality of optical sections and/or guidance sections as modules. Especially, as all sections, optical sections and guidance sections, respectively, share the same first connection interface and second connection interface, respectively, all sections can be arranged in arbitrary order. Also adding and/or removing one or more sections for changing the setup of the beam line according to the present invention is possible without any problems. A plurality of possible implementations of the beam line according to the present invention can thereby be provided.

In addition, the beam line according to the present invention can be improved further by that a pair of optical sections altering and/or controlling a direction of the laser beam are arranged on each other using their respective first connection interface and second connection interface for forming a joint of the modular beam line, wherein the modular beam line can be rotated and/or pivoted at said joint by rotating the optical sections with respect to each other. As the two optical sections forming the joint of the modular beam line are both enabled to alter and/or control the direction of the laser beam, rotating said optical sections with respect to each other provides the possibility of arbitrarily changing the initial direction of the laser beam at the first section opening of the respective upstream optical element of the joint, into a resulting direction of the laser beam at the second section opening of the respective downstream optical element of the joint. Depending on the respective change of direction of the laser beam provided by each of the two optical sections, a plurality of possible changes in direction of the laser beam can be provided by a joint of the modular beam line constructed as described in this paragraph.

According to a further improvement of the embodiment of the beam line according to the present invention described above, the optical sections are constructed according to claim 6 of the present invention. This includes in particular that the two optical sections forming the joint each comprise an optical element arranged in the respective section cavity, wherein the optical element is capable of altering and/or controlling the direction of the laser beam such that a laser beam entering the respective section cavity parallel to a central axis of the first section opening leaves said section cavity parallel to a central axis of the second section opening, and wherein in both optical sections the central axis of the first section opening is perpendicular to the central axis of the second section opening. In other words, each of the two optical sections forming the joint alters the direction of the laser beam by 90°.

Further, the laser beam enters the joint essentially parallel to a central axis of the first section opening of the first optical section of the joint, and again leaves the joint likewise essentially parallel to a central axis of the second section opening of the second optical section of the joint. The latter is especially independent of both, the relative rotational position of the two optical sections forming the joint, and the relative rotational orientations of the respective optical section and the adjacently arranged next guidance section or optical section of the modular beam line. Hence, a change of an initial direction of the laser beam into a resulting direction comprising essentially each solid angle can be provided, in particular without altering the optical path of the beam line, limited only by the dimensions of the optical sections perpendicular to the respective directions of the laser beam.

According to a second aspect of the invention, the object is satisfied by a laser system for a thermal laser evaporation (TLE) system, comprising a laser source for providing a laser beam, and a beam line for guiding the laser beam from the laser source to a reaction chamber of the TLE system. The laser system according to the present invention is characterized in that the beam line is constructed according to the first aspect of the invention. In particular, the beam line is arranged with its source end at the laser source and the laser beam provided by the laser source enters the beam line through its source end and is guided within the beam line up to its chamber end, which again can be arranged and connected to a reaction chamber of the TLE system. In summary, the laser system according to the second aspect of the present invention provides all features and advantages described above with respect to a beam line according to the first aspect of the present invention.

Additionally, the laser system according to the present invention can further be characterized in that the laser system comprises a support structure, and wherein the laser source and the beam line are arranged at the support structure. By providing a common support structure for the laser source and the beam line, the positioning of said elements of the laser system relative to each other can be fixed. Especially, said fixation has not to be ensured by the arrangement of the source end of the laser beam at and/or on the laser source. In addition, even if the beam line is provided as self-supporting structure, arranging the beam line on an external support prevents it from tipping over as a whole.

Further, the laser system according to the present invention can comprise that the laser source provides an infrared laser beam with a wavelength between 0.1 μm and 1000 μm, preferably 10 μm, in particular wherein the laser source is a CO₂ laser source. Infrared lasers are commonly used in TLE systems, as they are providable with high intensity, especially also for continuous operation. On the other hand, UV lasers are suitable for evaporation and/or sublimation of a wide variety of source materials. Hence, by using a laser source which provides a laser beam with a wavelength in the ultraviolet (UV) or infrared (IR) region, a usage of the laser system according to the present invention in a TLE system can be made more suitable.

According to a third aspect of the present invention, the object is satisfied by a thermal laser evaporation (TLE) system comprising a reaction chamber fillable with a reaction atmosphere, a substrate arranged in the reaction chamber, one or more sources arranged in the reaction chamber, and a laser system for providing a laser beam for evaporating and/or sublimating a material of the source and/or for heating a material of the substrate. The TLE system according to the present invention is characterized in that the laser system is constructed according to the second aspect of the invention. The laser system according to the second aspect of the present invention comprises a beam line according to the first aspect of the present invention. In summary, the TLE system according to the third aspect of the present invention comprises all advantages already described above with respect to a beam line according to the first aspect of the present invention and with respect to a laser source according to the second aspect of the present invention.

In a TLE system the laser can be used for both, either evaporating or sublimating a source material, or heating of the material of the substrate, respectively. Such TLE systems are known in general. Source material evaporated and/or sublimated by an impinging laser beam is deposited onto a substrate provided as target. Additionally, or alternatively, a laser beam can also be used for heating the material of the substrate. The source material is provided as source element arranged in a source within the reaction chamber, wherein one or more sources are possible, in particular providing the same and/or different source materials. The laser beam impinges onto a surface, in most of the cases a top surface, of the source element, providing flux of evaporated or sublimated source material.

The source is arranged within a reaction chamber, which is sealable against ambient atmosphere and fillable with a reaction atmosphere. Said reaction atmosphere can be vacuum, in particular as low as 10⁻¹² hPa or even lower, or comprise reaction gases at pressures suitable for the material to be deposited, for instance a reaction gas providing oxygen for a deposition of an oxide of evaporated and/or sublimated elemental or compound source material. Maximum values tested with a working distance of 60 mm so far are as high as 10⁻² hPa. Still higher values are likely possible as deposition was possible without problems at 10⁻² hPa.

For both purposes of the laser beam, namely evaporation and/or sublimation of target material, and heating of substrate material, respectively, the laser beam is produced by a laser source of a laser system according to the second aspect of the present invention, and guided from the laser source to the reaction chamber by a beam line according to the first aspect of the present invention. The usage of said beam line according to the first aspect of the present invention also provides the possibility of altering and/or controlling properties of the respective laser beam.

The invention will be explained in detail in the following by means of embodiments and with reference to the drawings. In particular, in the figures are shown:

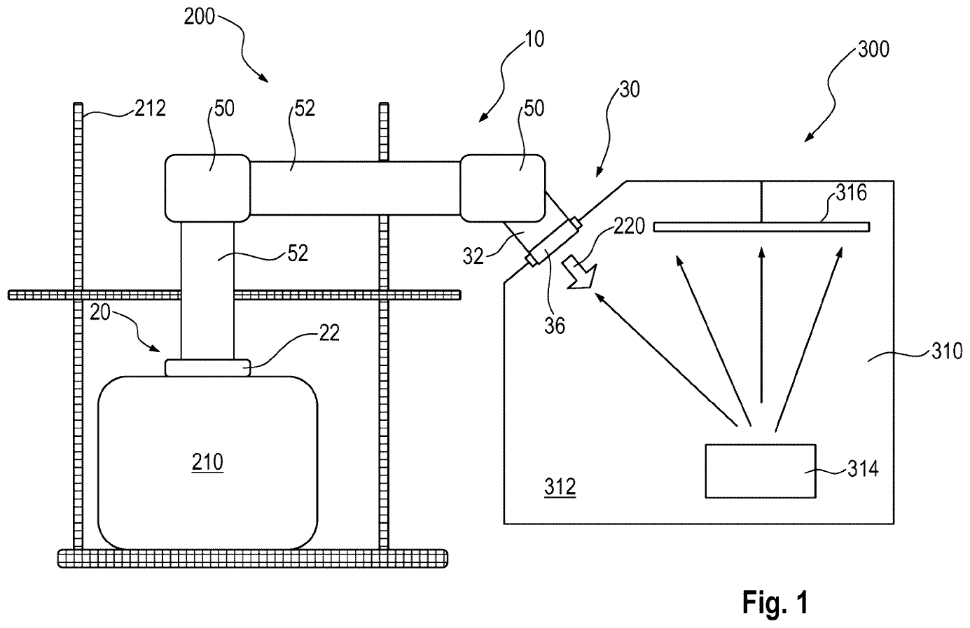

FIG. 1A TLE system according to the present invention,

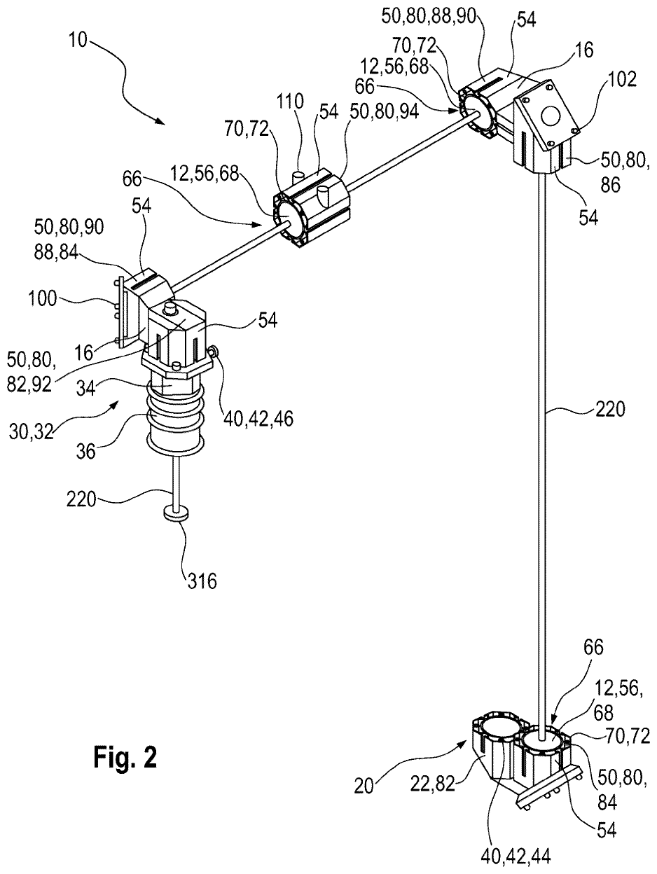

FIG. 2A first partial view of a beam line according to the present invention,

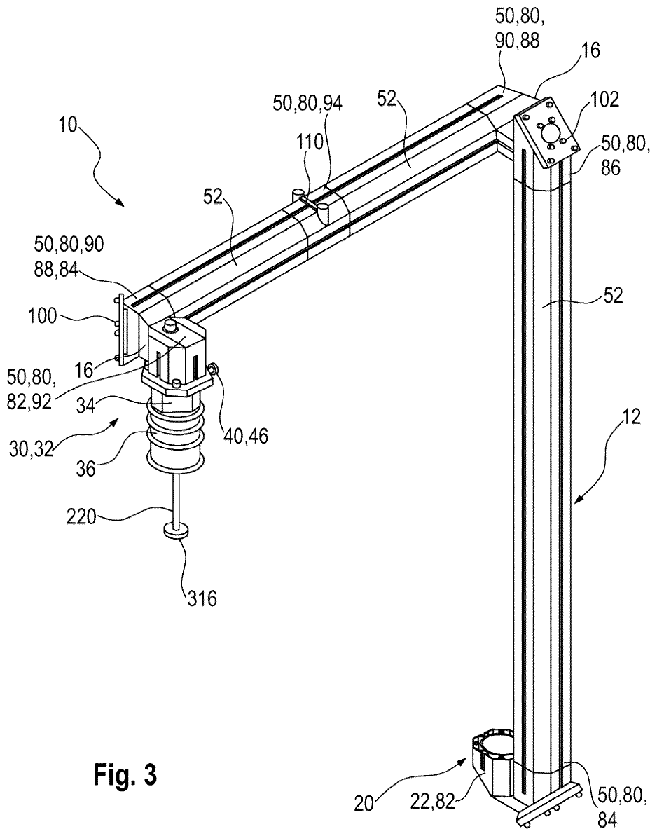

FIG. 3 The beam line of FIG. 2 in a second view,

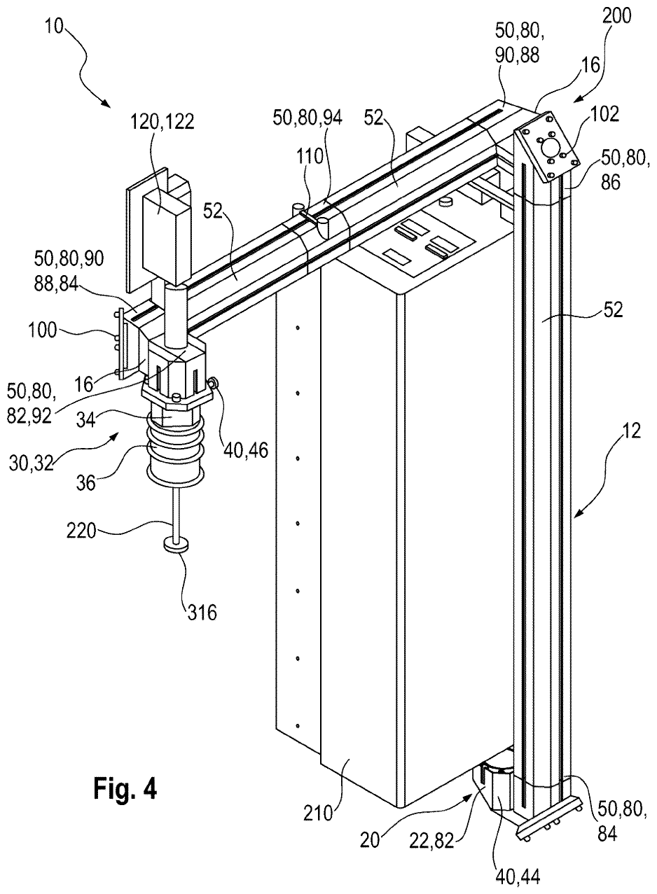

FIG. 4A laser system according to the present invention with the beam line of FIG. 2,

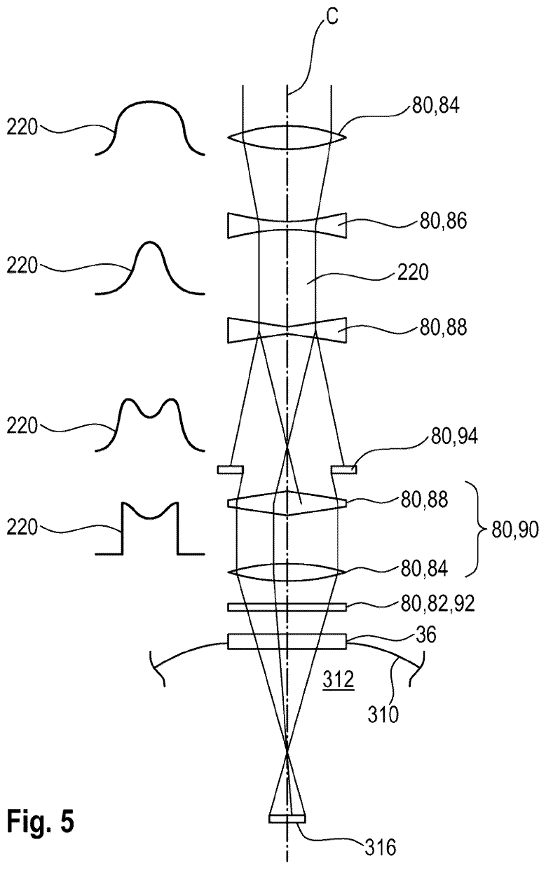

FIG. 5A laser beam guided by the beam line of FIG. 2,

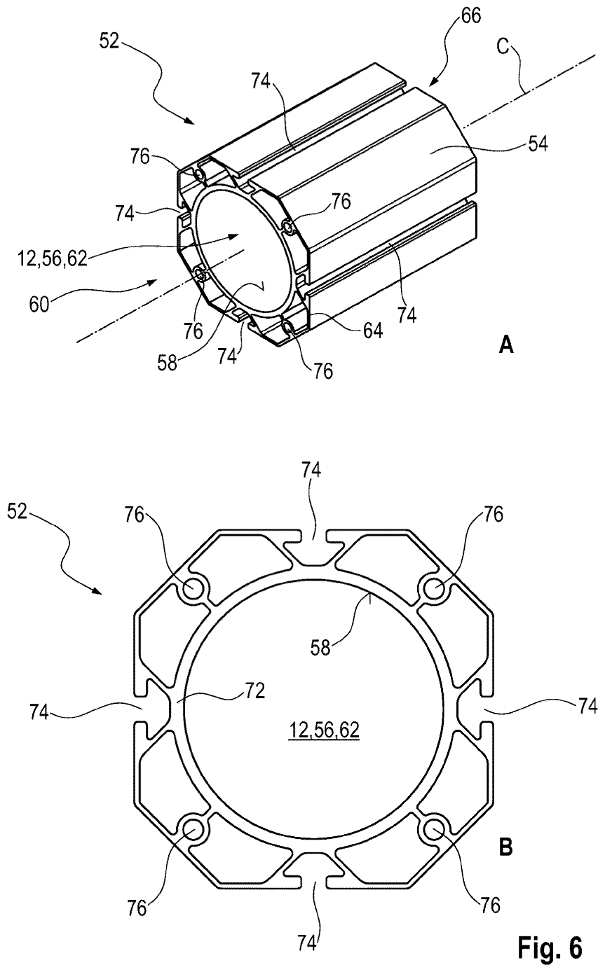

FIG. 6A guidance section of a beam line according to the present invention,

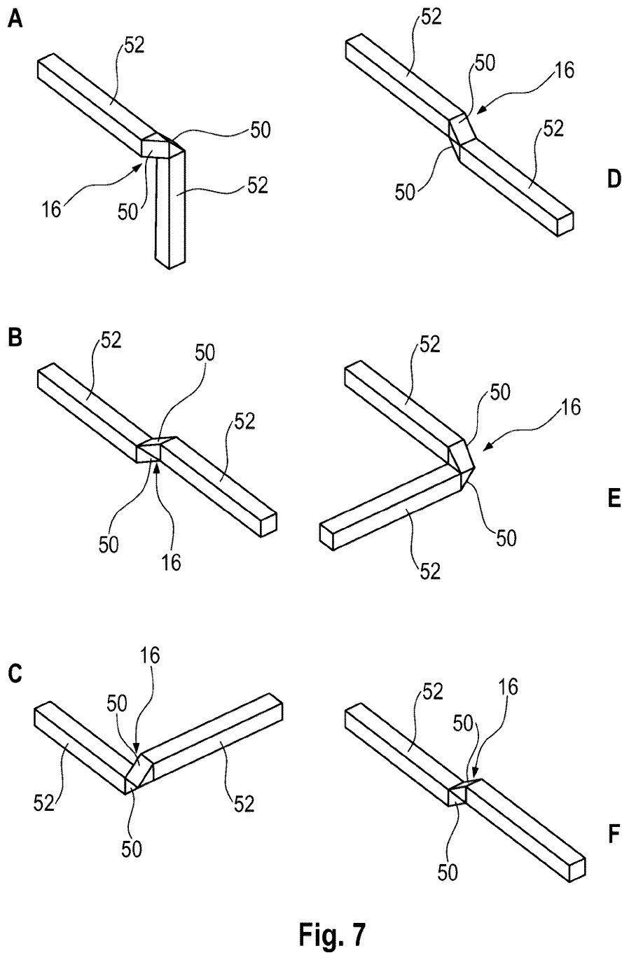

FIG. 7 Possible arrangements of a joint of a modular beam line according to the present invention, and

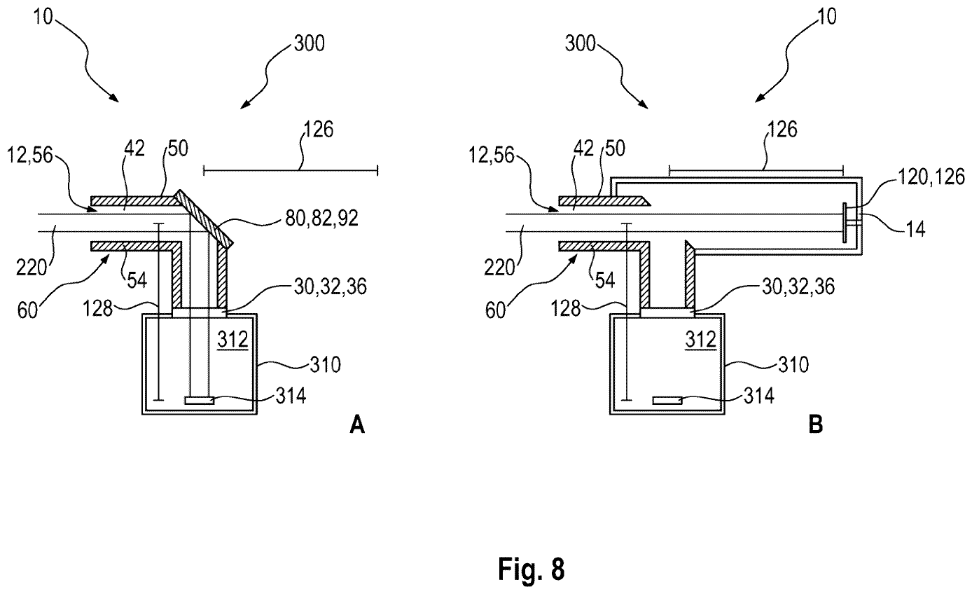

FIG. 8 Example of beam diagnostic with a beam line according to the present invention.

In FIG. 1, a schematic representation of a TLE system 300 according to the present invention is depicted. In particular, the TLE system 300 comprises a reaction chamber 310 and a laser system 200 according to the present invention, which itself comprises a support structure 212, a laser source 210, and a beam line 10 according to the present invention.

The reaction chamber 210 is filled with a reaction atmosphere 312. Further, a source 314 with material to be evaporated and/or sublimated and a substrate 316 with material to be coated is arranged in the reaction chamber 310. In the depicted embodiment of the TLE system 300, the laser beam 200 provided by the laser system 200 is used for evaporation and/or sublimation of the material of the source 314. However, also the substrate 316 can be heated by a laser beam 220, which likewise can be provided by an accordingly constructed laser system 200 according to the present invention.

As already mentioned, the laser system 200 comprises a laser source 210 which produces a laser beam 220. Said laser beam 220 can preferably be an infrared laser beam 220, for instance with a wavelength about 10 μm. For guiding the laser beam 220 from the laser source 210 to the reaction chamber 310, a beam line 10 according to the present invention is used. A common support structure 212 of the laser system 200 supports both, laser source 210, and beam line 10, respectively, and hence provides on the one hand secure fixation and mechanical support of said elements of the laser system 200, and on the other hand ensures a fixed relative positioning of the laser source 210 and the beam line 10 with respect to each other.

The beam line 10 extends between a source end 20 and a chamber end 30. The source end 20 is formed by a laser entry section 22, which is connected gas tight and light tight to the laser source 210. The laser entry section 22 already comprises a flat mirror 82 for deflection of the laser beam 220. Analogous, the chamber end 30 is formed by a chamber exit section 32, which again is connected gas tight and light tight to the reaction chamber 310. In particular, the chamber exit section 32 comprises the chamber window 36, which is arrangeable at a respective flange of the reaction chamber 310.

In the depicted embodiment, the beam line 10 is a modular beam line 10 comprising two guidance sections 52 and two optical sections 50. All sections 50, 52 share the same connection interfaces 64, 70 (see FIG. 2, 6) and can be adjacently arranged in arbitrary order. In particular, all sections 50, 52 are mechanically rigid or at least inherently stiffenable. Further, the sections 50, 52 are connectable in pairs by accordingly constructed first connection interfaces 64, provided at an upstream end 60 of the respective section 50, 52, and second connection interfaces 70, provided at a downstream end 66 of the respective section 50, 52, such that also this connection is mechanically rigid (FIG. 2, 6). In other words, the beam line 10 according to the present invention preferably is self-supporting.

The optical sections 50 are used for altering and/or controlling properties of the laser beam 220, as depicted for instance a direction of the laser beam 220. The guidance sections 52 extend linearly and straight. In summary, the beam line 10 according to the present invention provides gas tight and light tight connection between the laser source 210 and the reaction chamber 310, wherein the laser beam 220 is guided within the beam line 10 and wherein further properties of the laser beam 220 are altered and/or controlled for meeting the operational requirements of the TLE system 300.

FIGS. 2 to 4 depict a possible embodiment of a beam line 10 according to the present invention and of a respective laser system 200 according to the present invention with said beam line. Additionally, FIG. 5 shows a laser beam 220 guided through said beam line 10, wherein part of altering of the properties of the laser beam 220 along its way through said beam line 10 are depicted. In the following, FIGS. 2 to 5 are described together.

FIG. 2 shows in particular the optical sections 50 of the beam line 10. For a visibility of the laser beam 220, the guidance sections 52 (see FIGS. 3, 4) are not shown. This allows depicting three downstream ends 66 of the optical sections 50. As the beam line 10 is again a modular beam line 10, the visible downstream ends 66 are representative for all downstream ends 66 and correspond to accordingly constructed upstream ends 60 (see FIG. 6) of all sections 50, 52. All downstream ends 66 comprise a second section opening 68 of the respective section cavity 56 and a second connection interface 70 with an elastomer seal 72 surrounding the second section opening 68 for a gas tight and light tight connection.

Further, the laser entry section 22, the chamber exit section 32, and a substrate 316, which is in the depicted embodiment the destination of the laser beam 220, are depicted. The chamber exit section 32 comprises, likewise to the embodiment depicted in FIG. 1, the chamber window 36, which can be arranged at a respective flange of a reaction chamber 310 of a TLE system 300 (see FIG. 1). Further, the depicted chamber exit section 32 comprises a bellows 34 for mechanically decoupling the laser system 200 including the beam line 10 from the reaction chamber 310, for instance for preventing the transmission of vibrations between the respective parts of the TLE system 300.

The depicted beam line 10 comprises six optical sections 50, wherein each of the optical sections acts as mechanical support for an optical element 80 for altering and/or controlling properties of the laser beam 220. Said optical elements 80 are also depicted in FIG. 5. Please note that all optical elements 80, despite the aperture 94, are provided as mirrors and are in FIG. 5 depicted as lenses for illustration purpose only. All optical elements 80 provided as mirrors reflect the incoming laser beam 220 by 90°, hence at least alter the direction of the laser beam 220.

Preferably, the optical elements 80, or at least an active part of the respective optical element 80, are machined out of a monolithic block of metal, in particular copper or aluminum. This holds true for mirrors 82, 84, 86, 88, 90 and also for the aperture 94. This allows providing optical elements 80 with high precision with respect to their optical properties. Further, metals, in particular copper, comprise a high thermal conductivity. Hence laser energy nevertheless deposited into the respective optical element 80 is well distributed within the optical element 80. Further, also cooling of said metal blocks can be provided easily, in particular cooling ducts for respective cooling means 100 can be machined directly into the monolithic metal block forming the optical element 80.

Additionally, in FIG. 5, the laser beam 220 is depicted. On the right-hand side continuously through the optical elements 80, on the left-hand side again next to them, intensity cross-sections represent local intensity distributions of the laser beam 220.

As depicted in FIG. 5, the laser beam 220 is parallel to a central axis C throughout its way in the beam line 10. This is in particular provided by the construction of each of the optical sections 80 such that a laser beam 220 entering the section cavity 56 of the respective optical section 50 parallel to a central axis C of the respective first section opening 62 (see FIG. 6) leaves the section cavity 56 parallel to a central axis C of the respective second section opening 68. Further, the section cavities 56 of the guidance sections 52 (see FIG. 3, 4, 6) extend linear from the first section opening 62 to the second section opening 68 along a common central axis C of the first section opening 62 and the second section opening 68 of the respective guidance section 52.

Additionally, the intensity distribution of the laser beam 220 preferably is rotationally symmetric or has a twofold symmetry if all joints have rotations of integer multiples of 180°, a threefold symmetry if all joints have rotations of integer multiples of 120°, a fourfold symmetry if all joints have rotations of integer multiples of 90°, a fivefold symmetry if all joints have rotations of integer multiples of 72°, a sixfold symmetry if all joints have rotations of integer multiples of 60°, an eightfold symmetry if all joints have rotation of integer multiples of 45°, and so on.

With reference to FIGS. 2 and 5, the laser beam originating from the laser source 210 at first impinges onto a focusing mirror 84. Next, an optical section 50 follows with a defocusing mirror 86 as optical element 80. Hence, this first pair of optical sections 50 form a beam telescope, essentially altering the radius and hence the size of the laser beam 220. At least the defocusing mirror 86, preferably also the focusing mirror 84, are constructed as adjustable mirror, in particular as a reflective membrane on a cushion. The amount of fluid in the cushion can be regulated with a regulating connector 102 accessible from outside of the beam line 10. Hence, the size of the laser beam can be actively adjusted during operation of the laser system 200 by adjusting the filling of the respective cushion of the defocusing mirror 86 and/or the focusing mirror 84.

Directly adjacent to the optical section 50 with the defocusing mirror 86, an optical section with an axicon mirror 88 is arranged. Thereby, the optical section 50 with the defocusing mirror 86 and the optical section 50 with the axicon mirror 88 form a joint 16 of the modular beam line 10. Said axicon mirror 88 changes the spatial shape of the intensity distribution of the laser beam 220, see FIG. 5.

An optical section 50 further downstream with a complementary axicon mirror 88, which is formed as freeform mirror 90 for also acting as a focusing mirror 84, reverts the changes of the intensity distribution of the laser beam 220. Said freeform mirror 90 is further constructed as an adjustable mirror, the spatial orientation of which can be adjusted by adjustment screws 100 accessible from outside of the beam line 10.

However, between the two axicon mirrors 88, an optical section 50 with an aperture 94 as optical element 80 is arranged, selectively cutting the outer parts of the laser beam 220 and hence altering the shape of the intensity distribution of the laser beam 220.

As mentioned in the previous paragraph, the aperture 94 is used for cutting the laser beam 220, in particular by absorbing parts of the laser beam 220. For preventing harm caused by the absorbed laser energy, the aperture 94 is equipped with cooling means 110. Said cooling means can for instance comprise a coolant flowing through cooling ducts within the aperture 94. Preferably, inlets and/or outlets for said coolant are accessible from outside of the beam line 10.

In the specific embodiment shown, the upstream face of the aperture 94 is coated with an oxide absorbing layer, preferentially a rough, plasma spray coated sapphire layer with a thickness of 0.5 mm. This facilitates the absorption of the excess laser light of the laser beam 220, as this layer is in direct, intimate contact with the fluid-cooled body of the aperture 94 and thereby conducts the heat efficiently to fluid cooling ducts of the cooling means 110.

Finally, the last optical section 50 comprises a Bragg mirror 92 as optical element 80, providing on the one hand a very wavelength selective reflection of the laser beam 220 by 90°, and on the other hand allowing the implementation of a pyrometer 122 as diagnostic means 120 for directly measuring the temperature of the object heated by the laser beam 220, see FIG. 4.

Further, the aforementioned optical section 50 with the freeform mirror 90 and the optical section 50 with the Bragg mirror 92 are arranged directly adjacent with respect to each other. Thereby, said optical sections 50 form a second joint 16 of the modular beam line 10.

In addition to the parts of the beam line 20 already depicted in FIG. 2, FIG. 3 also shows the guidance sections 52. All guidance sections 52 are arranged between the optical sections 50, thereby forming the beam line 10. The section cavities 56 in the respective housing 54 of the guidance sections 52 connect to the respective section cavities 56 of the optical sections 50, forming a continuous beam cavity 12 extending between the source end 20 of the beam line 10 to the chamber end 30 of the beam line 10. In particular, the beam cavity 12 is a gas tight and light tight volume. Hence, it is possible to provide a flow of purge gas 42, for instance pure nitrogen and/or dry air, in the beam cavity 12, provided by a gas system 40 and flowing from an inlet 44 provided in the laser entry section 22 to an outlet 46 provided in the chamber exit section 32. However, also alternative and not depicted setups of the gas system 40 are possible, with the inlet 44 at the chamber exit section 32 and the outlet 46 at the laser entry section 22, or even with inlet 44 or outlet 46 somewhere along the beam cavity 12 and respectively outlet 46 or inlet 44 at one or both ends of the beam cavity 12.

Finally, in FIG. 4, also the laser source 210 and the already mentioned pyrometer 122 are depicted.

FIG. 6 shows a possible embodiment of a guidance section 52, in which the housing 54 is provided as extruded aluminum section. In subfigure A an isometric view, in subfigure B a sectional view of the guidance section 52 is depicted. Subfigure A in particular shows the upstream end 60 or the respective guidance section 52 with its first section opening 62 providing access to the section cavity 56 of the guidance section 52, which essentially forms a part of the beam cavity 12 of the beam line (see FIGS. 2 to 4). At least the surface 58 of said section cavity 56 is preferentially anodized for providing a relatively thick oxide layer for absorbing any scattered parts of the laser beam 220.

Further at the upstream end 60, a first connection interface 64 is arranged, comprising for instance an elastomer seal 72 (see subfigure B) surrounding the first section opening 62 and threaded holes 76 for a gas tight and light tight connection to an accordingly constructed second connection interface 70 on a downstream end 66 of an optical section 50 (see FIG. 2) or of another guidance section 52. The threaded holes 76 are arranged in the upstream end 60 in a 90° rotationally symmetric pattern. Grooves 74 in the housing 54 of the guidance section 52 allow a secure and especially easy fixation on an external support structure 212 (see FIG. 1).

In FIG. 7, a joint 16 of a modular beam line 10 according to the present invention is depicted in six exemplarily configurations shown in subfigure A to F. The joint 16 is formed by a pair optical sections 50 altering and/or controlling a direction of the laser beam 220, which are arranged on each other using their respective first connection interface 64 (not depicted) and second connection interfaces 70 (see FIG. 2). Each of the optical sections 50 can alter the direction of the laser beam 220 by 90°, wherein the laser beam 220 stays parallel to a spatially present central axis C throughout the joint 16. Depending on the relative rotational orientation of the two optical sections 50 with respect to each other, and on the relative rotational orientation of each of the optical sections 50 to its adjacently arranged guidance section 52, almost all solid angles can be reached with the modular beam line 10 by rotating and/or pivoting the joint 16, limited only by the size of the optical sections 50 forming the joint 16 perpendicular to the laser beam 220 and hence to their respective central axis C.

Again, the stepping of possible angles depicted in FIG. 7 is only limited to multiples of 90° for the clarity of the example. When using bolts and threaded holes 76 (see FIG. 6), other integer divisions of 360°, such as 180°, 120°, 72°, 60°, 45°, 30°, 20°, 10°, 5° etc. are possible. When using different ways of connecting the optical sections 50 and/or guidance sections 52, such as for instance clamping means, any rotation angle in each connection plane is possible, allowing truly any angle and orientation between the first and second guidance sections 52 in the example geometry of FIG. 7

Additionally, or alternatively, to the pyrometer 122 depicted in FIG. 4, also other possibilities for beam diagnostic means 120 are possible as parts of a beam line 10 according to the present invention. One of these possibilities is depicted in FIG. 8. Subfigure A of FIG. 8 depicts a working mode of the TLE system 300 equipped with the respectively equipped beam line 10, subfigure B the same TLE system 300 in a measuring mode.

In the working mode (subfigure A), the laser beam 220 is deflected by the optical element 80, in particular a Bragg mirror 92, of the last optical section 50 of the beam line 10 by 90°, arranged in the section cavity 56, which is part of the beam cavity, enclosed by the housing 54 of the optical section 50. After the deflection, the laser beam 220 enters the reaction chamber 310 filled with a reaction atmosphere 312 through a chamber window 36, which is in the depicted embodiment part of the chamber exit section 32 forming the chamber end 30 of the beam line 10. Within the reaction chamber 310, the laser beam 220 impinges onto a source 314 for evaporation and/or sublimation of material of said source 314, or on a substrate for heating of the substrate. Please note that the source 314 or substrate is distanced at a working distance 128 from the Bragg mirror 92.

In contrast to that, in measurement mode (subfigure B), the Bragg mirror 92 is removed and an additional beam line element 14 is attached in such a way at the optical element 50 that it essentially extends along the direction of the laser beam 220 initially present at the upstream end 60 of the optical section 50. Alternatively, the additional beam line element 14 can permanently be attached to the optical section 50.

Within the beam line element 14, a detector 124 is arranged as diagnostic means 120, in particular at a position in a measurement distance 126 distanced to the original position of the removed Bragg mirror 92. As detector 124, a camera, a beam monitor, a canvas or a thermal paper, can be used. Said measurement distance 126 is chosen accordingly to the working distance 128, preferably identical to the working distance 128. By that, the beam profile of the laser beam 220 at the position of the detector 124 is essentially identical to the beam profile of the laser beam 220 at the position of the source 314 or substrate, despite possible small distortions caused by the chamber window 36 and the Bragg mirror 92. In summary, diagnostic of the laser beam 220 at the position of the source 314 or substrate can be provided without breaching the closure of the reaction chamber 310.

### LIST OF REFERENCES

10 Beam line
12 Beam cavity
14 Beam line element
16 Joint
20 Source end
22 Laser entry section
30 Chamber end
32 Chamber exit section
34 Bellows
36 Chamber window
40 Gas system
42 Purge gas
44 Inlet
46 Outlet
50 Optical section
52 Guidance section
54 Housing
56 Section cavity
58 Surface
60 Upstream end
62 First section opening
64 First connection interface
66 Downstream end
68 Second section opening
70 Second connection interface
72 Elastomer seal
74 Groove
76 Threaded hole
80 Optical element
82 Flat mirror
84 Focusing mirror
86 Defocusing mirror
88 Axicon mirror
90 Freeform mirror
92 Bragg mirror
94 Aperture
100 Adjustment screw
102 Regulating connector
110 Cooling means
120 Diagnostic means
122 Pyrometer
124 Detector
126 Measurement distance
128 Working distance
C Central axis
200 Laser system
210 Laser source
212 Support structure
220 Laser beam
300 Thermal laser evaporation system
310 Reaction chamber
312 Reaction atmosphere
314 Source
316 Substrate

1-45. (canceled)

46. Beam line for a laser beam of a thermal laser evaporation system, the beam line extending between a source end of the beam line and a chamber end of the beam line, whereby the source end is connectable to a laser source and the chamber end is connectable to a reaction chamber of the TLE system,
the beam line comprising two or more of:
one or more optical sections for altering and/or controlling properties of the laser beam, and/or
one or more linear guidance sections;
wherein each of the optical sections and of the guidance sections, respectively, comprises a housing with an upstream end comprising a first connection interface, a downstream end comprising a second connection interface, and a section cavity continuously extending within the housing from a first section opening in the upstream end to a second section opening in the downstream end,
wherein the one or more optical sections and the one or more guidance sections are arranged adjacent in pairs such that the respective section cavities form a continuous beam cavity extending from the source end to the chamber end, and
wherein each section pair of adjacently arranged optical sections and/or guidance sections are arranged by connecting the first connection interface of one section of the section pair and the second connection interface of the other section of the section pair.

47. Beam line according to claim 46,
wherein the first connection interfaces and the second connection interfaces are adapted with respect to each other for providing a gas tight and/or light tight connection of the respective section cavities.

48. Beam line according to claim 47,
wherein both the first connection interfaces and the second connection interfaces comprise one or more respective arrangement spaces for precisely fitting alignment elements of the beam line for aligning the section pair of adjacently arranged optical sections and/or guidance sections.

49. Beam line according to claim 48,
wherein the arrangement spaces surround the respective section opening and the alignment element is ring-shaped, and/or
wherein the arrangement spaces are bores and the alignment element is a screw or bolt for fixing the respective section pair of adjacently arranged optical sections and/or guidance sections on each other.

50. Beam line according to claim 47,
wherein, for providing a gas tight and/or light tight connection of the respective section cavities, the first connection interfaces comprise an elastomer seal surrounding the first section opening and/or the second connection interfaces comprise an elastomer seal surrounding the second section opening.

51. Beam line according to claim 46,
wherein the one or more optical sections comprise an optical element arranged in the respective section cavity, wherein the optical element is capable of altering and/or controlling one or more properties of a laser beam entering the section cavity through the first section opening such that the altered laser beam leaves the section cavity through the second section opening.

52. Beam line according to claim 51,
wherein the optical element is capable of altering and/or controlling the laser beam such that a laser beam entering the section cavity essentially parallel to a central axis of the first section opening leaves the section cavity essentially parallel to a central axis of the second section opening.

53. Beam line according to claim 52,
wherein the central axis of the first section opening is perpendicular to the central axis of the second section opening.

54. Beam line according to claim 46,
wherein the section cavity of the one or more guidance sections extends linearly from the first section opening to the second section opening along a common central axis of the first section opening and the second section opening.

55. Beam line according to claim 46,
wherein the beam line comprises a laser entry section, wherein the laser entry section forms the source end, comprises a second connection interface, and is connectable in a gas tight and/or light tight manner to the laser source, and/or wherein the beam line comprises a chamber exit section, wherein the chamber exit section forms the chamber end, comprises a first connection interface, and is connectable in a gas tight and/or light tight manner to the reaction chamber.

56. Beam line according to claim 55,
wherein the chamber exit section comprises a bellows and/or the laser entry section comprises a bellows.

57. Beam line according to claim 55,
wherein the chamber exit section comprises a chamber window, which is arrangeable at a flange of the reaction chamber.

58. Beam line according to claim 46,
wherein the beam line comprises a gas system for providing a flow of purge gas within the beam cavity.

59. Beam line according to claim 58,
wherein one or more inlets of the gas system for injecting the purge gas into the beam cavity, and one or more outlets of the gas system for extracting the purge gas out of the beam cavity are connected to the beam cavity such that the flow of purge gas is provided within essentially the entire beam cavity between the source end and the chamber end.

60. Beam line according to claim 55,
wherein one or more inlets of the gas system for injecting the purge gas into the beam cavity, and one or more outlets of the gas system for extracting the purge gas out of the beam cavity are connected to the beam cavity such that the flow of purge gas is provided within essentially the entire beam cavity between the source end and the chamber end, and wherein the inlet is connected to the laser entry section and the outlet is connected to the chamber exit section.

61. Beam line according to claim 55,
wherein one or more inlets of the gas system for injecting the purge gas into the beam cavity, and one or more outlets of the gas system for extracting the purge gas out of the beam cavity are connected to the beam cavity such that the flow of purge gas is provided within essentially the entire beam cavity between the source end and the chamber end, and wherein the outlet is connected to the laser entry section and the inlet is connected to the chamber exit section.

62. Beam line according to claim 55,
wherein one or more inlets of the gas system for injecting the purge gas into the beam cavity, and one or more outlets of the gas system for extracting the purge gas out of the beam cavity are connected to the beam cavity such that the flow of purge gas is provided within essentially the entire beam cavity between the source end and the chamber end, and wherein one inlet is connected to the laser entry section and one inlet is connected to the chamber exit section and one outlet is connected to the beam cavity between the source end and the chamber end, or
wherein one outlet is connected to the laser entry section and one outlet is connected to the chamber exit section and one inlet is connected to the beam cavity between the source end and the chamber end.

63. Beam line according to claim 58,
wherein dry air or pure nitrogen is used as purge gas.

64. Beam line according to claim 46,
wherein the respective housings of the one or more optical sections and the one or more linear guidance sections are mechanically rigid or at least inherently stiffenable, and wherein the first connection interfaces and the second connection interfaces are adapted with respect to each other for providing a mechanically rigid connection.

65. Beam line according to claim 46,
wherein the housing of the one or more linear guidance sections is a tubular extruded aluminum section.

66. Beam line according to claim 65,
wherein grooves for fixation on a support structure are provided on an outer surface of the housing.

67. Beam line according to claim 46,
wherein one or more threaded holes are provided in the first connection interface and/or in the second connection interface of the housing.

68. Beam line according to claim 67,
wherein two or more threaded holes are arranged around the respective first section opening and/or second section opening in a rotational symmetric pattern around a central axis of the respective first section opening and/or second section opening.

69. Beam line according to claim 67,
wherein the first connection interface and the second connection interface are provided rotationally symmetric, and whereby the beam line comprises clamping means for securely fixing a section pair of adjacently arranged optical sections and/or guidance sections.

70. Beam line according to claim 46,
wherein the surface of the section cavity is anodized for providing an oxide layer on said surface of the section cavity.

71. Beam line according to claim 46,
wherein the one or more optical sections alters and/or controls one or more of the following properties of the laser beam:
Direction;
Size;
Shape;
Polarization;
Focal length; and
Intensity distribution.

72. Beam line according to claim 71,
wherein the respective optical element of the one or more optical sections comprises one or more of the following elements:
A flat mirror;
A focusing mirror;
A defocusing mirror;
An axicon mirror;
A freeform mirror;
A Bragg mirror;
A diffractive mirror or grating; and
An aperture.

73. Beam line according to claim 71,
wherein the active part of the respective optical element of the one or more optical sections is machined out of a monolithic block of metal.

74. Beam line according to claim 70,
wherein the optical element of the one or more optical sections comprises an actively adjustable mirror.

75. Beam line according to claim 74,
wherein a spatial orientation of the actively adjustable mirror can be adjusted by adjustment screws and/or wherein the actively adjustable mirror comprises a reflective membrane on a cushion fillable with an adjustment fluid.

76. Beam line according to claim 75,
wherein the adjustment screws and/or a regulating connector for the adjustment fluid are accessible from the outside of the housing of the respective optical section.

77. Beam line according to claim 46,
wherein the one or more optical sections comprise cooling means for actively cooling the respective optical element.

78. Beam line according to claim 73,
wherein the one or more optical sections comprise cooling means for actively cooling the respective optical element, and wherein the cooling means comprise cooling ducts for a coolant machined in and/or into the monolithic block of metal forming the active part of the respective optical element.

79. Beam line according to claim 46,
wherein the beam line comprises beam diagnostic means for measuring properties of the laser beam.

80. Beam line according to claim 79,
wherein the beam diagnostic means comprise a pyrometer for measuring the temperature of an optical element of one of the optical sections.

81. Beam line according to claim 79,
wherein an optical element of one of the optical sections altering the direction of the laser beam by 90° can be removed and an additional beam line element is arranged and/or arrangeable at the position of the optical element or along the original direction of the laser beam, wherein the beam diagnostic means comprise a detector arranged at a measuring position in the additional beam line element.

82. Beam line according to claim 81,
wherein the one of the optical sections is the last optical section before the chamber end and a measurement distance of the measuring position to the position of the removed optical element is chosen according to a working distance of the removed optical element to a substrate or source in the reaction chamber.

83. Beam line according to claim 81,
wherein the detector is a camera and/or a beam monitor and/or a canvas and/or a thermal paper.

84. Beam line according to claim 46,
wherein the beam line is a modular beam line comprising a plurality of optical sections and/or guidance sections as modules.

85. Beam line according claim 84,
wherein a pair of optical sections altering and/or controlling a direction of the laser beam are arranged on each other using their respective first connection interface and second connection interface for forming a joint of the modular beam line, wherein the modular beam line can be rotated and/or pivoted at said joint by rotating the optical sections with respect to each other.

86. Beam line according to claim 85,
wherein the optical sections comprise an optical element arranged in the respective section cavity, wherein the optical element is capable of altering and/or controlling one or more properties of a laser beam entering the section cavity through the first section opening such that the altered laser beam leaves the section cavity through the second section opening.

87. Laser system for a thermal laser evaporation system, comprising a laser source for providing a laser beam, and a beam line for guiding the laser beam from the laser source to a reaction chamber of the TLE system,
wherein the beam line extends between a source end of the beam line and a chamber end of the beam line, whereby the source end is connectable to a laser source and the chamber end is connectable to a reaction chamber of the TLE system,
the beam line comprising two or more of:
one or more optical sections for altering and/or controlling properties of the laser beam, and/or
one or more linear guidance sections;
wherein each of the optical sections and of the guidance sections, respectively, comprises a housing with an upstream end comprising a first connection interface, a downstream end comprising a second connection interface, and a section cavity continuously extending within the housing from a first section opening in the upstream end to a second section opening in the downstream end,
wherein the one or more optical sections and the one or more guidance sections are arranged adjacent in pairs such that the respective section cavities form a continuous beam cavity extending from the source end to the chamber end, and
wherein each section pair of adjacently arranged optical sections and/or guidance sections are arranged by connecting the first connection interface of one section of the section pair and the second connection interface of the other section of the section pair.

88. Laser system according to claim 87,
wherein the laser system comprises a support structure, and wherein the laser source and the beam line are arranged at the support structure.

89. Laser system according to claim 87,
wherein the laser source provides an infrared laser beam with a wavelength between 0.1 μm and 1000 μm.

90. Thermal laser evaporation system comprising a reaction chamber fillable with a reaction atmosphere, a substrate arranged in the reaction chamber, one or more sources arranged in the reaction chamber, and a laser system for providing a laser beam for evaporating and/or sublimating a material of the source and/or for heating a material of the substrate,
wherein the laser system comprises a laser source for providing a laser beam, and a beam line for guiding the laser beam from the laser source to a reaction chamber of the TLE system,
wherein the beam line extends between a source end of the beam line and a chamber end of the beam line, whereby the source end is connectable to a laser source and the chamber end is connectable to a reaction chamber of the TLE system,
the beam line comprising two or more of:
one or more optical sections for altering and/or controlling properties of the laser beam, and/or
one or more linear guidance sections;
wherein each of the optical sections and of the guidance sections, respectively, comprises a housing with an upstream end comprising a first connection interface, a downstream end comprising a second connection interface, and a section cavity continuously extending within the housing from a first section opening in the upstream end to a second section opening in the downstream end,
wherein the one or more optical sections and the one or more guidance sections are arranged adjacent in pairs such that the respective section cavities form a continuous beam cavity extending from the source end to the chamber end, and
wherein each section pair of adjacently arranged optical sections and/or guidance sections are arranged by connecting the first connection interface of one section of the section pair and the second connection interface of the other section of the section pair.
